(19) United States
(12) Patent Application Publication
(10) Pub. No.: US 2007/0033532 A1
(43) Pub. Date: Feb. 8, 2007

(54) Method and apparatus for generating web content

(76) Inventor: Gregory M. Lemelson, Roslindale, MA (US)

Correspondence Address: E P TREMBLAY & ASSOCIATES PC, 30 LOGAN ST, SWANSEA, MA, 02777, US

(21) Appl. No.: 11/198,841

(22) Filed: Aug. 5, 2005

(51) Int. Cl. G06Q 20/00

(52) U.S. Cl. 715/741; 705/22; 705/400

(57) ABSTRACT

The invention is directed to techniques for generating web content to enable use of existing web content on a secondary web platform. Embodiments of the invention first extract an element of product content from product content for rendering a web page of a first web platform. The web content generator identifies whether the element of product content is authorized for use on a second web platform. If the element extracted is authorized for a second web platform, the element of product content is designated to be valid as web content for the second web platform. If not, the web content generator substitutes an authorized replacement product content element for the extracted element of product content. If no such authorized replacement product content element is available, the program generator designate the non-authorized extracted element of product content as needing replacement.

### BACKGROUND OF THE INVENTION

As the age and sophistication of the Internet progresses, the complexity of e-commerce systems (Internet systems for the purchase and sale of products over the Internet) also increases. Increasingly also, companies that would otherwise want to market products (and/or services) over the Internet lack the technical skill needed to be successful in e-commerce channels. In response to this void of technical skills and knowledge, various companies provide technical assistance and products such as basic e-commerce templates, forms, etc. to help ease the development burden for product and service companies seeking to have an Internet presence. Some Internet companies provide selling assistance within their user communities whereby sellers who are more experienced help other sellers sell by doing such things as providing photographing products, performing basic hypertext mark-up language (HTML) design and assisting in developing title, subtitle descriptions, choosing key words, etc. At the other end of the third party service spectrum, third party vendors provide comprehensive Internet marketing and management services and/or services for a commission or fee.

Another significant development in the Internet landscape is the evolution of multiple-vendor sites such as web malls and auction sites. These sites provide access to different types of products and services offered by a wide variety of vendors both large and small. One such well-known site is eBay®. In addition to straightforward product marketing, the price setting/market-making feature of online auctions has captured the attention of a large consuming audience. Vendor participation in these platforms provides vendor access to a large market of participating users.

Vendors gain access to the auction platforms by providing vendor and product content to the auction site. Certain auction web sites accept such information via a data entry screen. Some of web sites accept software code that is configured to perform a display or some other desired function. The software code may be HTML or some other form of software code for displaying content on a web site.

### SUMMARY OF THE INVENTION

In order to access the large marketplace of a multi-vendor web site or an auction site such as eBay®, a vendor first provides data to the web site or auction site about the products or services that the vendor is offering for sale. For example, eBay® vendors enter product content into an online “sell to” form that has fields for product title, description, price, etc. Part of the “sell to” form is a dialog box into which vendors can paste a copy of a section of HTML coded software. The eBay® web site assimilates the vendor's product content (that includes HTML software code) and renders both within the eBay® structured web site platform.

Many vendors evaluate the possible advantages of marketing their products on multi-vendor web sites as well as other third party web sites such as the auction web sites. However, preparation of web content for multiple web site platforms has an added cost. Preparation of the product content for certain of the additional web sites may also include creation of software code needed to display the product and other related data. Furthermore, if entry of the product content is a manual process the added cost for re-entry may be significant. Although the term multi-vendor web site is employed herein, the principles described with respect to multi-vendor web sites are also applicable to the employment of multiple web sites, as well.

However, embodiments of the web content generator overcome this obstacle, by providing an improved method for re-formulating product content used in a first web site for re-use in one or more additional web sites. Thus the web content generator divides the product content into elements. The web content generator evaluates each element in such a fashion as to identify if the product content element is authorized (i.e. allowed) for use on second or other additional web platform. Authorization of the product content refers to one or more of a variety of characteristics of the product content.

For the most part authorization refers to whether the content, format or operation associated with an element of product content is acceptable for use in the destination web platform. For example, certain auction web sites do not maintain a Suggested Retail Price for products marketed on its site. Therefore the Suggested Retail Price is not authorized for use in an auction web site. Since there is no alternative value with which to replace the suggested retail price, the product generator does not replace the value with an alternative value.

Another authorization criteria is the formatting such as for example, formatting related to the size of the secondary web platform web pages. In one such case, if a secondary a web site platform has headers and/or footers which are used to identify the look and feel of the site, product content from the vendor's primary web site may not fit a secondary web site on which the product may be displayed. In order to fit the content within the reduced page size, elements of the product content are formatted in a different manner as to fit the secondary web site.

Another example has to do with processing of product content. Operators of a multi-vendor web site for example may not want users of their web site to access any web addresses outside of the multi-vendor web site. For example, the operators of the multi-vendor web site may want to prevent vendors from providing links to advertising, order entry or other functions while the users access the multi-vendor web site. Accordingly, HTML code providing outside web addresses would be considered unauthorized. Thus the web content generator replaces such unauthorized code (i.e. also referred to herein as product content) with corresponding authorized code.

The product content may alternatively be kept in the form of software code for generating a web site display or in another format. According to one embodiment of the invention, the web content generator generates product content formatted in a similar or the same format as that of the first web site. For example, the web content generator may be configured to re-format product content used on its main web site so that when displayed from a third party web site such as an auction platform, the web pages duplicates the look and feel of the main web site. In that way, the vendor is able to create brand recognition for its products within the auction site.

According to one embodiment of the invention, in addition to being kept as source code for the first web site (e.g. such as the vendor's primary web site) the vendor may actually store product content in a database or other information storage mechanism, as well. For example, according to one embodiment of the invention, the vendor maintains an order entry/inventory system in which product content is stored. The product content in the database is accessible to the vendor's primary web site. Customers access product content in the process of initiating purchases through the vendor's primary web site. In reformulating product content from a first web site for use in a multi-vendor web site the web content generator extracts product content from the database and reformulates the product content to create content for the multi-vendor web site.

In order to reformulate product content, the web content generator must generate web content for the multi-vendor web site in an acceptable format for operation of the multi-vendor web site. For example, the multi-vendor web site may be a platform such as an auction web site controlled by 3rd party (e.g. eBay®). Accordingly, the operator of the multi-vendor web site 150 may enforce restrictions upon product content allowed on its web site. Often operators of web platforms maintain such restrictions in order to insulate users from the outside world. In reformulating content from the first web site, the web content generator may provide replacement product content and/or software code for the unauthorized product content that the auction web site operators do not allow on their platform or alternatively, generate a notification that replacement product content is needed.

For example, certain web platforms prohibit the use of certain types of Java script or Java code or alternatively restrict vendors' software from accessing other web sites to perform certain functions. Additionally, certain web platforms may require order entry to be performed within the web platform rather than from the vendor's outside web site. Another example is that vendor's software code may not be authorized to access advertising from another web site. However, the vendors' software code may be authorized to perform other functions such as obtaining product technical information or other content.

If the format in which product content (e.g. including product content provided in the form of software code) is maintained on the vendor's first web site is not allowed by the operator of the multi-vendor web site, the web content generator must generate replacement content that is acceptable for the multi-vendor web site platform. Accordingly the web content generator first extracts an element of the product content. If the extracted product content is authorized for use on the second or destination web platform, the web content generator combines the extracted product content with other elements of software code and/or other product content to create web content for the multi-vendor web site. But if extracted product content is not authorized for the second web platform, the web content generator substitutes replacement product content for the extracted element of product content. The web content generator then combines replacement product content (e.g. or software) with other product content.

This process is repeated as many times as necessary to generate the needed web content for the second web platform. Accordingly, the web content generator provides a method for efficiently converting large amounts web content configured for one web platform into a form suited for a second web platform. Furthermore, the process can be automated so as to cause web content for the second web platform to be re-formulated whenever updates to the product content from a first web site occur. For example, the web content generator can be built into the back-end of the vendor's primary web site.

### BRIEF DESCRIPTION OF THE DRAWINGS

The foregoing and other objects, features and advantages of the invention will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a system for efficiently converting large amounts web content configured for vendor web site into a configuration for a multi-vendor web site, according to one embodiment of the invention.

FIG. 2 is a flow chart of a procedure for generating the web content for the second web platform, according to one embodiment of the invention.

FIG. 3 is a detailed flow chart of a procedure for formatting authorized product content, according to one embodiment of the invention.

FIG. 4 shows a web page of an auction platform web page rendered on the multi-vendor web site, according to one embodiment of the invention.

FIG. 5 shows a web page of an auction platform in response to a user-initiated search selection, according to one embodiment of the invention.

FIG. 6 shows an eBay® platform web page in which a user review is depicted, according to one embodiment of the invention.

FIG. 7 shows an eBay® platform web page in which product statistics are depicted, according to one embodiment of the invention.

FIG. 8 shows a depiction of a general-purpose computer configured in such a manner as to be capable of generating web content, according to one embodiment of the invention.

### DETAILED DESCRIPTION

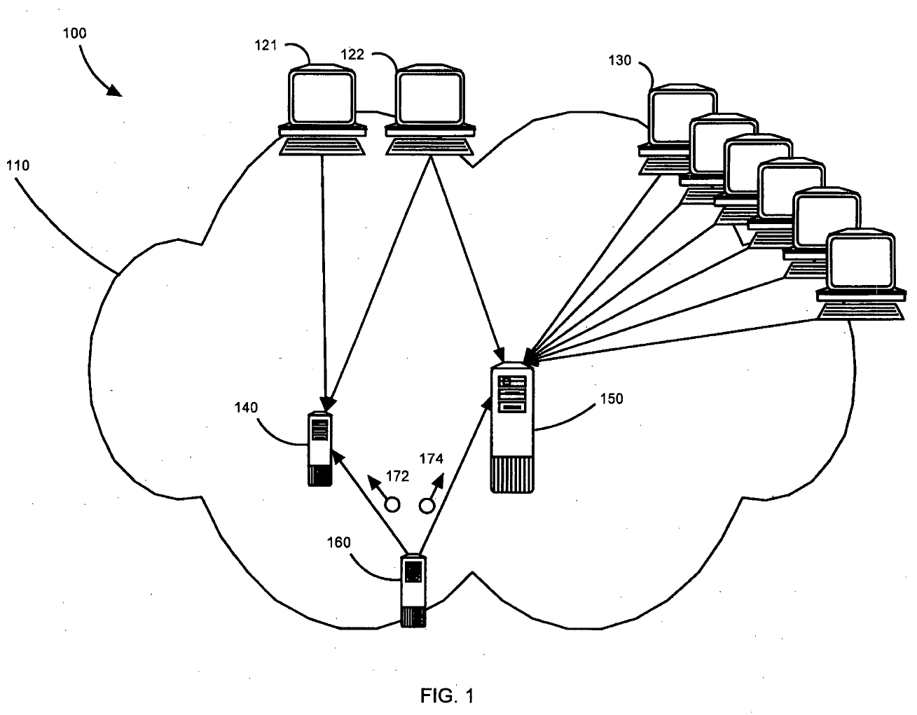

FIG. 1 shows the components of an e-commerce system 100 having a web content generator 160 as one of its components. The e-commerce trading system 100 comprises exemplary user computers 121, 122, 130, a server that represents a vendor web site 140 (referred to herein as the vendor web site 140), a server that represents a multi-vendor web site 150 (referred to herein as a multi-vendor Webster) and the web content generator 160. The web content generator 160 as described earlier, re-formulates and/or generates web content for one or more the multi-multi-vendor web sites 150. The product content 172 (i.e. web content) is provided to the vendor web site 140, or the web content generator 160 reformulates the product content 172 and provides the re-formulated product content 174 to the multi-vendor web site 150. Each of the components are interconnected via the Internet 1 10 represented in the figure by a network cloud.

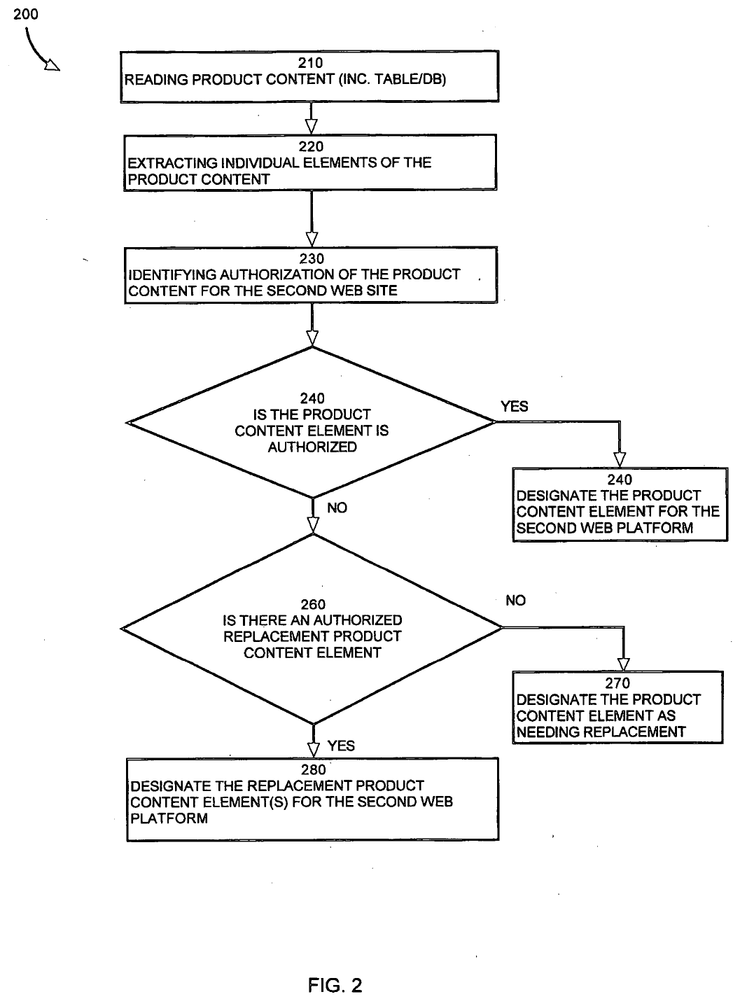

FIG. 2 is a flow chart of a procedure for generating the web content for multi-vendor web site. The procedure is particularly well suited for generating product content 174 for use in a second web platform (such as a multi-vendor web site 150) based on the product content 172 provided for use on a first platform.

In step 210, the web content generator 160 reads product content 172. The product content 172 may be obtained from a variety of sources. For example, the product content 172 may be obtained from product information maintained in a database or other data storage facility. The product content 170 may even be stored in the data base from which the vendor's business operations are normally conducted, that is from a data base of product descriptions, inventory, order entry, billing, etc. Alternatively, the product content 162 may be in the exact form used to render web pages that make up the web platform of the vendor web site 140.

In step 220, elements of the product content 170 information are extracted for analysis by the web content generator 160.

In step 230, the web content generator 160 identifies whether the extracted segment is authorized for use on the multi-vendor web site 150. There are a variety of reasons why product content may not be authorized for the multi-vendor web site 150. One reason is that product content 160 may not be authorized for the multi-vendor web site 150 is that the particular element of product content 160 may not be in an acceptable format to the operators of the multi-vendor web site 150.

For example, the product content may not be in the right format such as placing content, graphics or other items in the right locations, etc., the product content may use different types of files or sources. The formatting consideration possibilities are essentially limitless and therefore depending on the artistic and/or arbitrary choices made by the multi-vendor web site 150 operators. Accordingly, the multi-vendor web site 150 may set rules or guidelines about what type of formatting is allowed in the multi-vendor web site 150. Alternatively, vendors may establish restrictions about the size and/or amount of the products allowed on the multi-vendor web site 150 or any other of an almost limitless number of restrictions that the multi-vendor web site 150 operators can arbitrarily impose in their quest for creation of a particular environment for the multi-vendor web site 150. Other restrictions may be more technical nature. The operators of the multi-vendor web site 150 may allow vendors to provide software code that will render parts or all of the vendor's product information on the multi-vendor web site 150. However, restrictions may be placed limiting use of the software code.

The multi-vendor web site 150 may restrict the types of code that they will allow the vendor to use. For example, they may not allow Java® script or code to be uploaded to the multi-vendor web site 150. The multi-vendor web site 150 may require that the vendor's code does not store “cookies” on user's computers 120, 130 or make registry changes or additions to the user's registry files. The multi-vendor web site 150 may restrict the use of pop-ups, etc. Following is a partial list of web software code and web software code functions that multi-vendor web site 150 operators may restrict:

HTML used to drop or read a cookie on any eBay® page; HTML that redirects the user from eBay® to another page (such as the “replace” script); HTML that automatically calls remote scripts and pages (such as JavaScript includes or frames); HTML that changes registry entries, or otherwise writes to another's computer hard drive; HTML that creates automatic “pop-ups” except for links that open in a new window when clicked on; HTML that automatically posts to scripts in eBay®; HTML that automatically loads any binary program on another's computer except for Flash content; HTML or Java® Script that automatically overwrites any area on the listing outside of the item description area; Java® Script used to drop or read a cookie on any eBay® page; Java® Script that redirects the user from eBay® to another page (such as the “replace” script); Java® Script that automatically calls remote scripts and pages (such as Java® Script includes or frames); Java® Script that changes registry entries, or otherwise writes to another's computer hard drive; Java® Script that creates automatic “pop-ups” except for links that open in a new window when clicked on); Java® Script that automatically posts to scripts in eBay®, JavaScript that automatically loads any binary program on another's computer; HTML or Java® Script that automatically overwrites any area on the listing outside of the item description area.

In turn, web content generator 160 identifies replacement product content information that is valid for the multi-vendor web site 150.

In step 240, the web content generator 160 identifies element of product content 160 that aren't authorized for use on the multi-vendor web site 150. If the product content 160 is not authorized, steps are taken, as needed to provide appropriate replacement product content 160 that the multi-vendor web site 150 operators will allow on their web platform.

If the product content is not authorized, in step 260 the web content generator 160 determines if it has already existing replacement product content elements (these may be, alternatively, product content data, segments of software code, templates, etc.) with which to replace the offending product content 174. At this point it may be necessary for the web content generator 160 to reformat the extracted element of product content.

Replacements for the offending elements of product content may be found in a variety of ways. For example, there may be already existing segments of software code that can replace an offending segment of software code without further modification. In other cases, software code modifications may be required. Additional data may be needed, etc. Once replacement product content 160 (data and/or software code) is identified, it may be combined with other segments before it is provided to the multi-vendor web site 150. If there are no adequate means for providing replacement software code to replace an offending code segment, in step 270, the web content generator 160 designates the product content as being in need of replacement. Replacement of the product content 160 may require a manual operation, such as writing new software code segments, extracting or inputting new product content information to multi-vendor web site 150, etc.

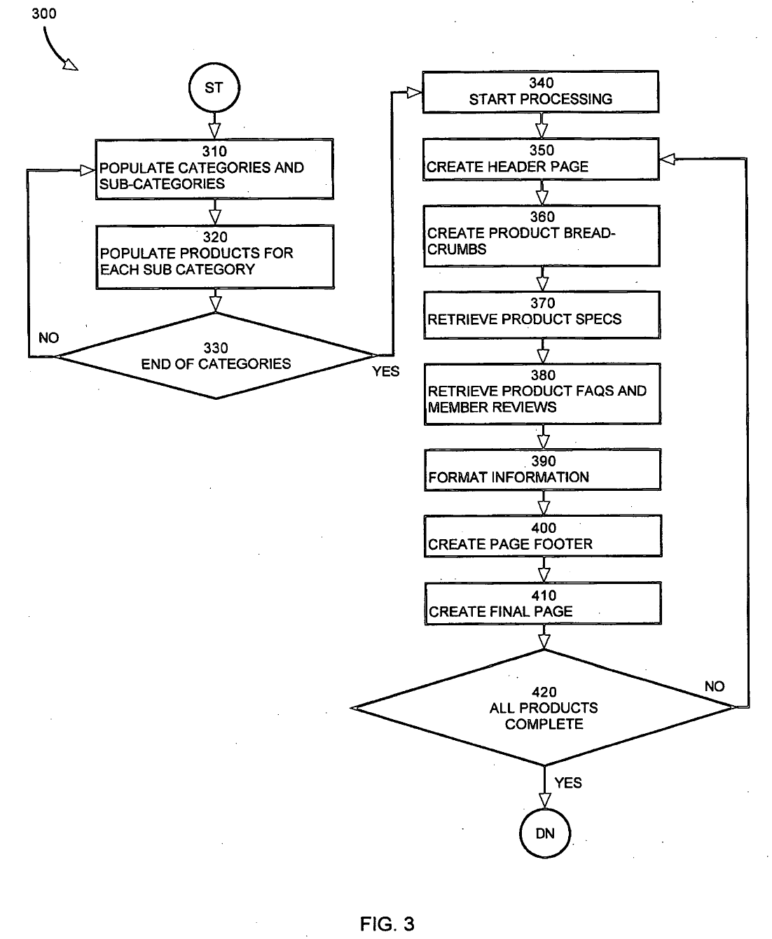

FIG. 3 is a flow chart of a procedure for formatting authorized product content. In particular, it starts by obtaining all of the categories and sub-categories that will be employed in the replacement product content 160. In step 310-330, the web content generator 160 populates an array of categories/sub-categories. From the list of categories and sub-categories, the vendor web site 140 generates a list of references to other points in the same or other web pages associated with the categories. These references become active on the multi-vendor web site 150 to point either to lists, search categories or individual products for efficient user navigation.

In the second part of the procedure from step 340 to step 410, the program generator 160 assembles parts of product content 174 into a web page document or documents.

In addition to the main script partially described in FIGS. 2 and 3, the following modules describe an integral part of functioning of the web content/eBay® auction page generator. Source code for the modules are provided in Appendix I. These modules contain various function definitions that are used in the process of the auction page generation.

Product

This module contains methods to set the various attributes for a product object like all the product categories, product name, description, parent product, price, specifications, reviews, statistics, ratings and corresponding stars, product cases, if they exist, icons and any other relevant attributes that need to be displayed on the product page.

Mem

This module contains functions to create a new member review object. This object instantiates a MemReview object, which in turn creates and formats individual member reviews.

FAQ

This particular module has capabilities to create and format FAQs pertinent to the product under consideration. It calls the Faq3 module to do this.

MemReview

The MemReview module retrieves and renders HTML for each individual member review. It constructs a Review object that contains function declarations and definitions that actually provide it with the functionality to do the same. This module is thus delegatory in nature.

FaqPool

This module provides functionality to see if FAQs exist for a particular product, and in case it does, it allows the caller to retrieve these FAQs.

Faq3

This class constructs one object for one screen view, i.e, it constructs an object constaining upto three FAQs at a time. It constructs an Faq (not FAQ) object that constructs individual FAQ objects, and Faq3 combines them.

Faq

This class/module constructs an FAQ object that contains one FAQ. It renders HTML for the FAQ, the member who asked the question and also the breadcrumb for the product or category that the FAQ refers to.

Review

This module/class constructs an individual member review and renders the HTML for displaying the review, and other review attributes like value, functionality, ease of use etc.

Icon

Each product has icons associated with it. This module contains methods to display the icons for the product under consideration. It also displays the various icon specifications.

Breadcrumb

This module contains function definitions and declarations that provide the application with the capability to display breadcrumbs at the top of the page. This module can render the links and provide each of the links with the proper text to search eBay®.

Template

This module is part of the Template toolkit. This module was not written as part of the ebay® auction generator exercise, but is an integral part of the application, since it provides the actual mechanics to populate the template with actual values.

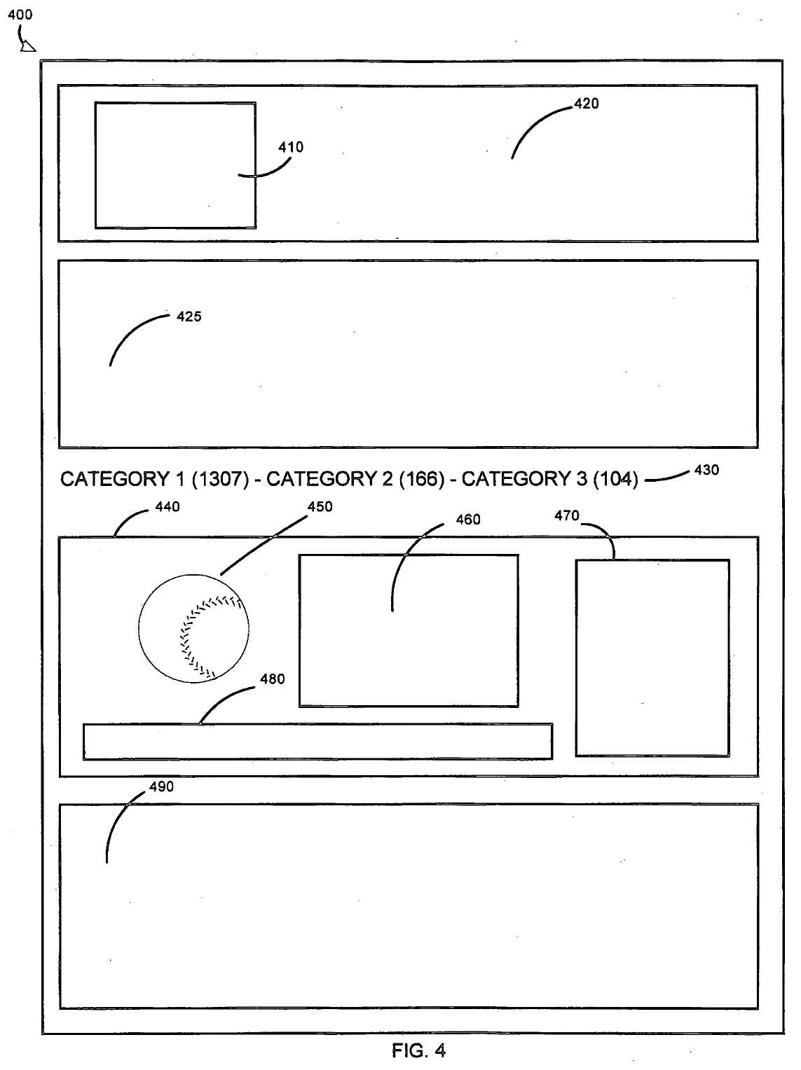

FIG. 4 shows a web page of an auction platform rendered on the multi-vendor web site 150. The web page contains content provided by the multi-vendor web site 150 (e.g. an auction site) and vendor product content generated by the web content generator 160. The web page includes the multi-vendor web site 150 logo 410 located in a multi-vendor web site header 420. The multi-vendor web site header 420 may contain other multi-vendor web site information such as table of content info and other miscellaneous information.

Additional multi-vendor web site product content 172 is displayed in the data section 425 of a web page. The web page also has category selection labels 430, vendor product specification section 440 and a final multi-vendor web site 150 section 490. The category selection labels 430 are user-selectable labels that serve as a jump-off point to aid in user navigation. Upon selection by a user, the multi-vendor web site 150 provides additional category-related information. Individual category references are generated from individual items contained in the product category list, as described earlier with respect to FIG. 3.

Within the product section are also found, vendor-provided graphics 450, product detail information 460, product evaluation information 480 and additional vendor information 470. Finally, the web page concludes with additional multi-vendor web site-provided information.

By combining the vendor-provided content 174 together with multi-vendor web site 150 provided content, the vendor creates a rich complement of information to enhance the buying experience. The information and presentation of the vendor product content 172 also provides an identification to the vendor due to the similarity to content found on the vendor's primary web site 140. The addition of the vendor's content integrate such features as bread crumbs, major product family links, sub-navigation links, overviews, product statistics including recommendations by other members, regular review link with a pop-up to write a review and a sign-in form, browse FAQ link which brings you to the FAQ section of the Amvona web site which provides dynamic changing content, submitted service request forms to submit service requests, specifications, member reviews, FAQ's, links to the testimonials page, member services, help desk, Open Source Virtual Photo School and a link to subscribe to the news letter part of the vendor web site 140 experience.

Embodiments of the invention provide a mechanism in which up-to-date information is constantly being updated. Accordingly a method is provided by which product content 174 on the multi-vendor web site 150 is easily maintained. As changes to the product content 172.on the vendor web site 140 occur they are easily transferred to the multi-vendor web site 150. The amount of coding needed to provide a multi-vendor web site 150 is dramatically reduced. Even complex product information involving changing prices, statistics or other quantitative information, changes in web software code are easily updated on the multi-vendor web site 150, thereby eliminating the necessity for undertaking extensive, expensive web site development projects. Therefore embodiments of the invention make it possible for a vendor to maintain a large amount of product content on a large number of multi-vendor web sites 150 that carry the vendor's products.

By simplifying the process of providing project content to multi-vendor web site 150, the program generator 160 makes it possibly for users to provide a rich and up-to-date web presence with minimal effort. The content on the third party web content generator 160 simplifies and speeds up the process of providing web content for a multi-vendor web site 150 to such an extent that it becomes feasible to maintain multiple web sites. Changes in the web content can easily be proliferated to one or more other networked web sites. For example, the web content generator 160 makes it possibly to organically maintain and keep up-to-date product content on the multi-vendor web site 150. Traditionally it is difficult to maintain such information as ratings for product value, function, appearance, etc. of the product. If the product content on the vendor web site changes the program generator 160 regenerates the program generator 160 to generate updates the multi-vendor web site 150. Such statistics may thenm be easily provided to the multi-vendor web site 150. Whenever changes occur, the product content is easily and/or automatically updated, such as updating the multi-vendor web site 150 on a regularly scheduled basis or as needed, only when changes have been turned over to ***made to the vendor web site 140 or based on some other timing. Of course, the program generator 160 can even change static information as needed.

In this way also, the product content provided by the vendor web site 140 is able to be intermixed on the same multi-vendor web site 150 product content 172 still allowing the multi-vendor web site 150 to maintain it's integrity and method of operation at the same time accommodating a variety of vendors. Vendors are able to maintain up-to-date product content 172, 174 at the same time exposing their products to a large customer base. For example, eBay®® is reputed as having 60 million customers at this time.

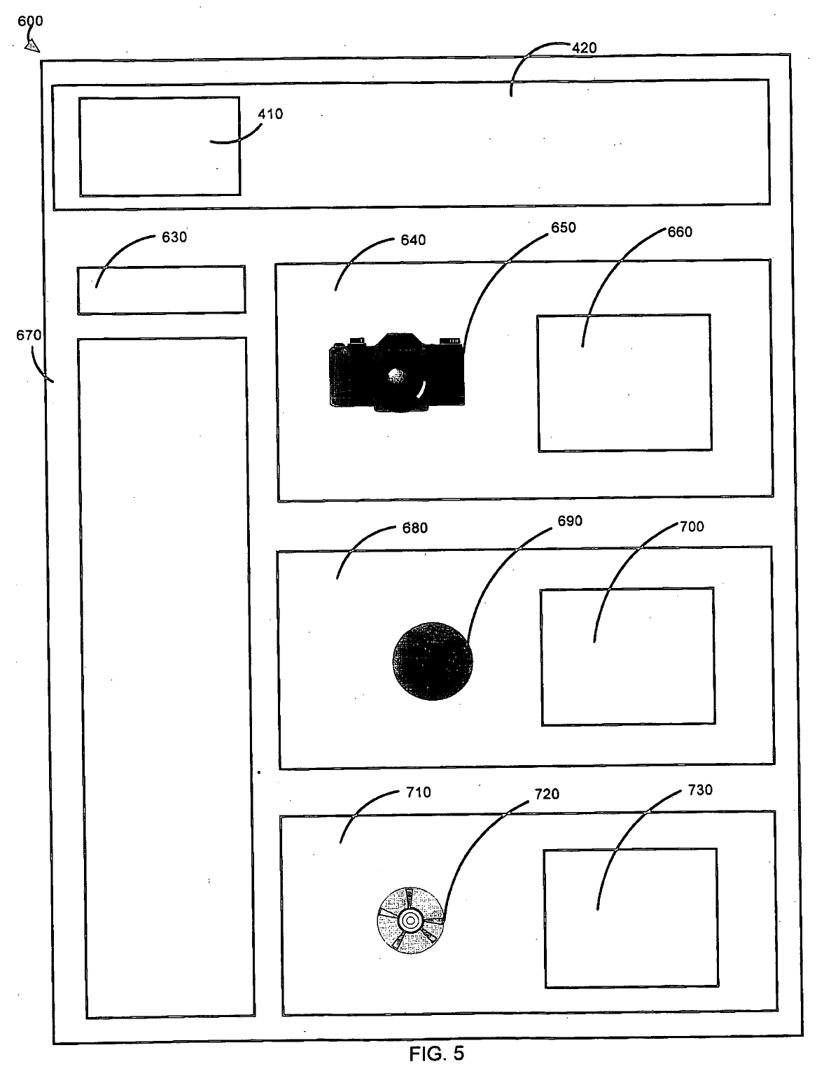

FIG. 5 is a search conducted within an auction web site. By associating search strings generated as part category analysis function described with respect to FIG. 3. It is possible to programmatically enter the search string thereby generating a search under vendor software control even within the auction site.

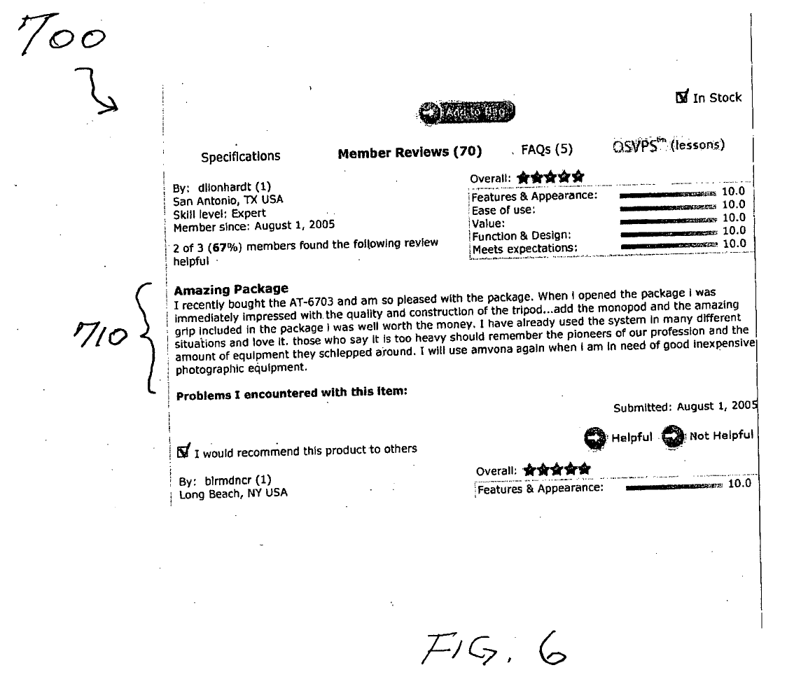

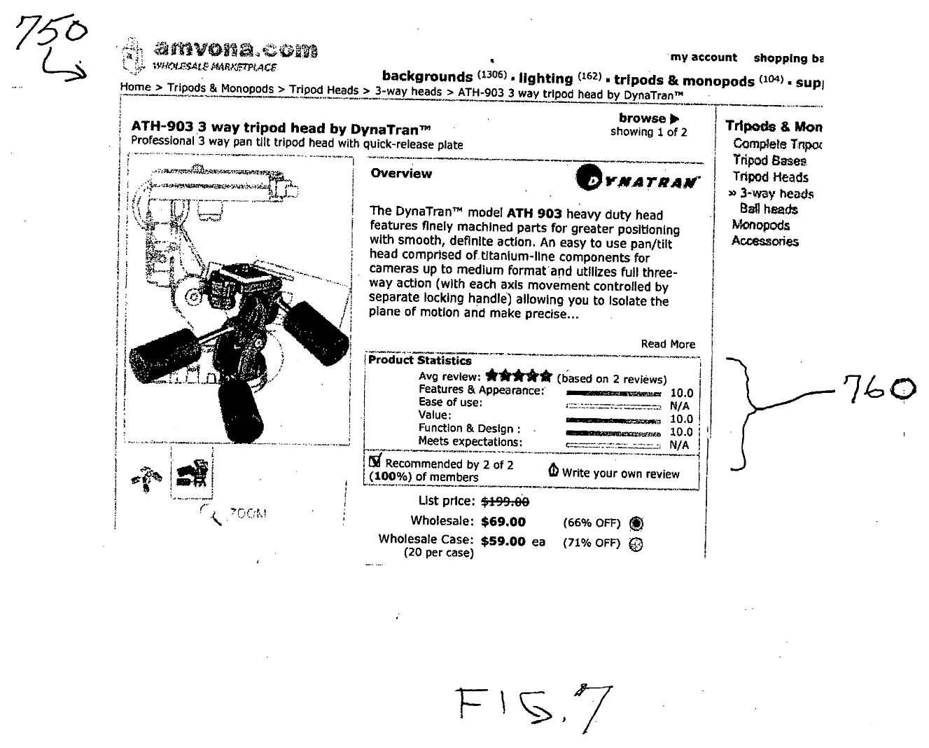

FIG. 6 shows an example of a member review of a vendor product displayed within the auction site 150. FIG. 7 shows up-to-date statistics, calculated on the vendor site 140 presented to a user within the auction site 150.

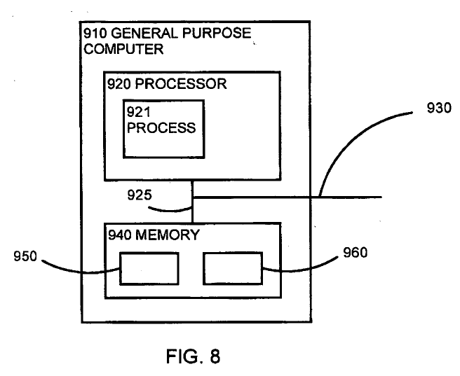

FIG. 8 shows a general-purpose computer 910 capable of generating product content 174 for use on a multi-vendor web site 150. The general purpose computer 910 comprises a processor 920 which operates a process 921, a memory 940, an interconnection mechanism 925 for connecting the processor 920 and the memory 940 as well as a communications interface 930 for communicating information from the general purpose computer 910 (e.g. or other computational device) to the Internet 110. The memory 940 comprises a program 950 and data 960. The general-purpose computer 910 also has a communications interface 930 for communicating information from the general-purpose computer 910 to the Internet 110. The program 950, operated as a process 921 in the processor 921, is configured to perform the steps of generating web content from the product content 174 and/or other data 960 stored in memory 940. The processor 920 processes data 960 stored on the memory 940. When the process 921 operates, it uses data 960 from memory 940 or another source obtained over the Internet 930 with which the general purpose or other computer generates product content 174 for use on the multi-vendor web site 150.

While this invention has been particularly shown and described with references to preferred embodiments thereof, it will be understood by those skilled in the art that various changes in form and details may be made therein without departing from the spirit and scope of the invention, as defined by the appended claims.

Also, other arrangements of embodiments of the invention that are disclosed herein include a computer program product that has a computer-readable medium 170 including computer program logic encoded thereon. When executed on at least one processor 920, the computer program product causes the processor 920 to perform the operations (e.g., the methods) indicated herein as embodiments of the invention. The embodiments of the invention may be implemented by computer software and/or hardware mechanisms within any of a variety of Internet, telecommunications, general purpose computing and/or other computational apparatii. It is to be understood that embodiments of the invention can be embodied strictly as a software program, as software and hardware, or as hardware alone.

What is claimed:

1. A method for generating web content comprising the steps of:
extracting an element of product content from product content for rendering a web page of a first web platform;
identifying whether the element of product content is authorized for use on a second web platform;
if the extracted element of product content is authorized for a second web platform, designating the element of product content as web content for a second web platform;
if the extracted element of product content is not authorized for the second web platform and an authorized replacement product content element exists, substituting the authorized replacement product content element for the extracted element of product content;
designating the authorized replacement product content as web content for the second web platform; and
if the extracted element of product content is not authorized for the second web platform and an authorized replacement product content element does not exist, designate the non-authorized extracted element of product content as needing replacement.

2. The method of claim 1 wherein the step of identifying whether the element of product content is authorized comprises the step of:
making a determination that the product content is not authorized if any of the following are performed: HTML is used to drop or read a cookie on any eBay® page, HTML that redirects the user from eBay® to another page (such as the “replace” script), HTML that automatically calls remote scripts and pages (such as JavaScript includes or iframes), HTML that changes registry entries, or otherwise writes to another's computer hard drive, HTML that creates automatic “pop-ups” except for links that open in a new window when clicked on, HTML that automatically posts to scripts in eBay®, HTML that automatically loads any binary program on another's computer except for Flash content, HTML or JavaScript that automatically overwrites any area on the listing outside of the item description area, JavaScript used to drop or read a cookie on any eBay® page, JavaScript that redirects the user from eBay® to another page (such as the “replace” script), JavaScript that automatically calls remote scripts and pages (such as JavaScript includes or iframes), JavaScript that changes registry entries, or otherwise writes to another's computer hard drive, JavaScript that creates automatic “pop-ups” except for links that open in a new window when clicked on), JavaScript that automatically posts to scripts in eBay®, JavaScript that automatically loads any binary program on another's computer, HTML or JavaScript that automatically overwrites any area on the listing outside of the item description area.

3. The method of claim 1 wherein the steps of extracting an element of product content and identifying further comprises the steps of extracting an element of product content and identifying whether the element of product content is authorized by an automated process.

4. The method of claim 3 further comprising the step of repeating the step of extracting an element of product content and identifying whether the element of product content is authorized by an automated procedure.

5. The method of claim 1 further comprising the steps of:
identifying the type of an element of product content from product content for rendering a web page of a first web platform;
choosing the appropriate method for configuring the element of product content from product content for rendering a web page on a first web platform for use on a second web platform according to the type of product content read; and
configuring the product content from product content for rendering a web page on a first web platform for use on a second platform.

6. The method of claim 5 wherein the step of identifying the type of product content comprises the step of determining the type of product content based on the storage address of the product content.

7. The method of claim 5 wherein the step of identifying the type of product content comprises the step of determining the type of product content based on the attributes of the product content.

8. The method of claim 5 wherein the step of identifying the type of product content comprises the step of determining the type of product content based upon the configuration of software code containing the element of product content for the first web platform.

9. The method of claim 5 wherein the step of determining the type of product content based upon the configuration of software code containing the segment of product content for the first web platform comprises the step of confirming that the software code is not configured to perform an unauthorized software function.

10. The method of claim 5 wherein the step of reconfiguring the product content comprises the steps of:
obtaining at least one category associated with a product item from the product content for rendering a web page of the first web platform, each category being associated with at least one product; and
associating each of the at least one categories to a search string chosen so as to be capable of searching, within the second web platform, the at least one product item associated with the category.

11. The method of claim 1 comprising the steps of creating an element of product content from at least one of an authorized operational function and an authorized product data item.

12. The method of claim 11 comprising the steps of creating an element of product content by reformatting a corresponding unauthorized element of product content so as to eliminate unauthorized operational functions and authorized product data.

13. The method of claim 1 wherein an authorization characteristic refers to the whether the web content is formatted according to a pre-defined alternative format.

14. The method of claim 1 wherein the steps of extracting an element of product content and identifying whether the element of product content is authorized by an automated procedure are automatically performed upon a change of an element of product content

15. The method for providing product content to an auction site comprising the step of providing as input to the auction site for assimilation into the auction site, at least one of a category heading, vendor-generated product specification, overview, picture, statistics, review, frequently asked questions and link to associated information, bread crumbs, major product family links, sub-navigation links, overview, product statistics including recommendations by other members, regular review link with a pop-up to write a review and a sign-in form, browse FAQ link which brings you to the FAQ section of the Amvona web site which provides dynamic changing content, submitted service request forms to submit service requests, specifications, member reviews, FAQ's, links to the testimonials page, member services, help desk, Open Source Virtual Photo School, a link to subscribe to the news letter, terms of use link.

16. The method of claim 15 further comprising the step of providing the at least one of the category heading, vendor-generated product specification, overview, picture, statistics, review, frequently asked question and link to associated information in such a manner that the at least one of the category heading, vendor-generated product specification, overview, picture, statistics, review, frequently asked question and link to associated information is positioned near the order processing location for the vendor's product.

17. The method of claim 15 wherein the at least one of the category headings, vendor-generated product specification, overview, picture, statistic, review, frequently asked question, and link to associated information input to the auction site for assimilation in the auction site near the order processing location for the vendor's product provides in the second web platform, a look-and-feel of the first web platform.

18. A method of displaying product statistics on an eBay® web platform for a product on sale on the eBay® web platform comprising the steps of:
calculating the statistics as used on a vendor's first web site; incorporating the calculated statistics into a web content item; and
inputting the web content item to the eBay® web platform for later display on the eBay® web site in connection with the associated product on sale;
wherein the product statistics include at least one of the following individual statistics: average review rating, features and appearance rating, ease of use rating, value rating, function and design rating meets expectations ratings.

19. A method of displaying a user product review on an eBay® web platform for a product on sale no the eBay® web platform comprising the steps of:
obtaining the user product review as used on a vendor's first web site;
incorporating the user product review into a web content item; and
inputting the web content item to the eBay® web platform for later display on the eBay® web site in connection with the associated product on sale.

20. A computer program product that includes a computer readable medium having instructions stored thereon for generating web content, such that when the instructions are carried out by a computer, the computer is capable of performing the steps of:
extracting an element of product content from product content for rendering a web page of a first web platform;
identifying whether the element of product content is authorized for use on a second web platform;
if the extracted element of product content is authorized for a second web platform, designating the element of product content as web content for a second web platform;
if the extracted element of product content is not authorized for the second web platform and a replacement authorized product content element exists, substituting the authorized replacement product content element for the extracted element of product content; and
designating the replacement authorized product content as web content for the second web platform; and
if the extracted element of product content is not authorized for the second web platform and an authorized replacement product content element does not exist, designate the non-authorized extracted element of product content as needing replacement.

21. The computer program product of claim 20 wherein the step of identifying whether the element of product content is authorized comprises the step of:
making a determination that the product content is not authorized if any of the following are performed: HTML is used to drop or read a cookie on any eBay® page, HTML that redirects the user from eBay® to another page (such as the “replace” script), HTML that automatically calls remote scripts and pages (such as JavaScript includes or iframes), HTML that changes registry entries, or otherwise writes to another's computer hard drive, HTML that creates automatic “pop-ups” except for links that open in a new window when clicked on, HTML that automatically posts to scripts in eBay®, HTML that automatically loads any binary program on another's computer except for Flash content, HTML or JavaScript that automatically overwrites any area on the listing outside of the item description area, JavaScript used to drop or read a cookie on any ebay® page, JavaScript that redirects the user from eBay® to another page (such as the “replace” script), JavaScript that automatically calls remote scripts and pages (such as JavaScript includes or iframes), JavaScript that changes registry entries, or otherwise writes to another's computer hard drive, JavaScript that creates automatic “pop-ups” except for links that open in a new window when clicked on), JavaScript that automatically posts to scripts in eBay®, JavaScript that automatically loads any binary program on another's computer, HTML or JavaScript that automatically overwrites any area on the listing outside of the item description area.

22. The computer program product of claim 20 wherein the steps of extracting an element of product content and identifying further performs the steps of extracting an element of product content and identifying whether the element of product content is authorized is performed as an automated process.

23. The computer program product of claim 22 further performing the step of repeating the steps of extracting an element of product content and identifying whether the element of product content is authorized by an automated procedure.

24. The computer program product of claim 20 further performing the steps of:
identifying the type of an element of product content from product content for rendering a web page of a first web platform; and
choosing the appropriate method for configuring the element of product content from product content for rendering a web page on a first web platform for use on a second web platform according to the type of product content read; and
configuring the product content from product content for rendering a web page on a first web platform for use on a second platform.

25. The computer program product of claim 24 wherein the step of identifying the type of product content comprises the step of determining the type of product content based on the storage address of the product content.

26. The computer program product of claim 25 wherein the step of identifying the type of product content comprises the step of determining the type of product content based on the attributes of the product content.

27. The computer program product of claim 25 wherein the step of identifying the type of product content comprises the step of determining the type of product content based upon the configuration of software code containing the element of product content for the first web platform.

28. The computer program product of claim 25 wherein the step of determining the type of product content based upon the configuration of software code containing the segment of product content for the first web platform comprises the step of confirming that the software code is not configured to perform an unauthorized software function.

29. The computer program product of claim 25 wherein the step of reconfiguring the product content comprises the steps of:
obtaining at least one category associated with a product item from the product content for rendering a web page of the first web platform, each category being associated with at least one product; and
associating each of the at least one categories to a search string chosen so as to be capable of searching, within the second web platform, the at least one product item associated with the category.

30. The computer program product of claim 20 comprising the steps of creating an element of product content from at least one of an authorized operational function and an authorized product data item.

31. The computer program product of claim 30 comprising the steps of creating an element of product content by reformatting a corresponding unauthorized element of product content so as to eliminate unauthorized operational functions and authorized product data.

32. The computer program product of claim 20 wherein an authorization characteristic refers to the whether the web content is formatted according to a defined alternative format.

33. The computer program product for providing product content to an auction site comprising the step of providing as input to the auction site for assimilation into the auction site, at least one of a category heading, vendor-generated product specification, overview, picture, statistics, review, frequently asked question and link to associated information.

34. The computer program product of claim 33 further performing the step of providing the at least one of the category heading, vendor-generated product specification, overview, picture, statistics, review, frequently asked questions and link to associated information, bread crumbs, major product family links, sub-navigation links, overview, product statistics including recommendations by other members, regular review link with a pop-up to write a review and a sign-in form, browse FAQ link which brings you to the FAQ section of the Amvona web site which provides dynamic changing content, submitted service request forms to submit service requests, specifications, member reviews, FAQ's, links to the testimonials page, member services, help desk, Open Source Virtual Photo School, a link to subscribe to the news letter, terms of use link.

35. The computer program product of claim 33 wherein the at least one of the category headings, vendor-generated product specification, overview, picture, statistic, review, frequently asked question, and link to associated information input to the auction site for assimilation in the auction site near the order processing location for the vendor's product provides in the second web platform, a look-and-feel of the first web platform.

36. The computer program product of claim 20 wherein the steps of extracting an element of product content and identifying whether the element of product content is authorized by an automated procedure are automatically performed upon a change of an element of product content

37. A method of displaying product statistics on an eBay® web platform for a product on sale on the eBay® web platform comprising the steps of:
calculating the statistics as used on a vendor's first web site; incorporating the calculated statistics into a web content item; and
inputting the web content item to the eBay® web platform for later display on the eBay® web site in connection with the associated product on sale;
wherein the product statistics include at least one of the following individual statistics: average review rating, features and appearance rating, ease of use rating, value rating, function and design rating meets expectations ratings.

38. A method of displaying a user product review on an eBay® web platform for a product on sale no the eBay® web platform comprising the steps of:
obtaining the user product review as used on a vendor's first web site;
incorporating the user product review into a web content item; and
inputting the web content item to the eBay® web platform for later display on the eBay® web site in connection with the associated product on sale.

39. An apparatus for generating web content comprising:
a memory that stores product content for rendering a web page of a first web platform;
a processor that identifies whether an element of the product content for rendering a web page of a first web platform is authorized for use on a second web platform;
if the extracted element of product content is authorized for a second web platform, designating the element of product content as web content for a second web platform;
if the extracted element of product content is not authorized for the second web platform and a replacement authorized product content element exists, substituting the authorized replacement product content element for the extracted element of product content; and
designating the replacement authorized product content as web content for the second web platform.

40. An apparatus for generating web content comprising:
a processor;
a memory;
a communications interface connecting the processor and memory;
means for extracting an element of product content from product content for rendering a web page of a first web platform;
means for identifying whether the element of product content is authorized for use on a second web platform;
if the extracted element of product content is authorized for a second web platform, designating the element of product content as web content for a second web platform;
if the extracted element of product content is not authorized for the second web platform and a replacement authorized product content element exists, substituting the authorized replacement product content element for the extracted element of product content; and
designating the replacement authorized product content as web content for the second web platform.
